(19) United States
(12) Patent Application Publication
(10) Pub. No.: US 2026/0022287 A1
(43) Pub. Date: Jan. 22, 2026

(54) DRILLING FLUIDS INCLUDING WETTABILITY MODIFIERS, AND RELATED METHODS

(71) Applicant: Schlumberger Technology Corporation, Sugar Land, TX (US)

(72) Inventors: Wei Lu, Houston, TX (US); Balakrishnan Panamarathupalayam, Houston, TX (US)

(21) Appl. No.: 19/273,946

(22) Filed: Jul. 18, 2025

Related U.S. Application Data
(60) Provisional application No. 63/673,300, filed on Jul. 19, 2024.

(51) Int. Cl. C09K 8/12; C09K 8/06; C09K 8/08; E21B 21/00

(52) U.S. Cl. CPC C09K 8/12; C09K 8/06; C09K 8/08; E21B 21/00

(57) ABSTRACT

A drilling fluid includes an aqueous base fluid including water, and salt, and a wettability modifier including one or more of a cationic ethoxylated alcohol including a quaternary ammonium cation, a cationic polymerized polyglucoside, a block copolymer of ethylene oxide and propylene oxide, a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid. Related methods of forming a borehole and related drilling fluids are also disclosed.

### CROSS REFERENCE TO RELATED APPLICATIONS

This application claims the benefit of U.S. Provisional Application Ser. No. 63/673,300, which was filed on Jul. 19, 2024, bears the same title, and is incorporated by reference in its entirety.

### BACKGROUND

Wellbore drilling operations include drilling a borehole in a subterranean earth formation to access hydrocarbon-containing reservoirs and/or other subsurface resources. During drilling of the borehole, various fluids may be circulated into the borehole through a drill pipe and drill bit, and may subsequently flow upward through the borehole to the surface. For example, a drilling fluid (e.g., an aqueous-based fluid or an oil-based fluid) may be pumped down the inside of the drill pipe, through the drill bit, and into the borehole, at least some of which may be cased and cemented to form a wellbore. The drilling fluid returns to the surface through the annulus between the earth formation and the drill pipe. The drilling fluid may lubricate and cool the drill bit, facilitate transport of formation cuttings to the surface, prevent formation of blowouts by maintaining a hydrostatic pressure greater on the formation than the formation pressure, maintain well stability, and reduce fluid loss to the formation.

Drilling fluids may be water-based (aqueous-based), or may be non-aqueous, such as oil-based or synthetic-based. The type of drilling fluid may be selected based, at least in part, on the type of subterranean earth formation being drilled. In many instances, aqueous-based drilling fluids are often preferred because such fluids may be lower in cost and/or may be more environmentally friendly than non-aqueous based drilling fluids. For example, many subterranean earth formations are water-wet, wherein surfaces of the subterranean earth formation are hydrophilic and are preferentially contacted by aqueous materials relative to oleaginous materials. Aqueous-based drilling fluids used in water-wet subterranean earth formations may infiltrate into the subterranean earth formation beyond a borehole during drilling operations. Infiltration of the aqueous-based drilling fluid may result in the loss of the drilling fluid to the subterranean earth formation and may cause damage to the earth formation and/or reservoirs from which hydrocarbons are to be recovered at a later stage. In some instances, infiltration of the aqueous-based drilling fluid into pores of the earth formation may reduce the efficacy of subsequent wellbore operations, such as stimulation and hydrocarbon recovery operations wherein hydrocarbons flow through the pores.

### BRIEF SUMMARY

In some embodiments, a drilling fluid includes an aqueous base fluid including water, and salt. The drilling fluid further includes a wettability modifier including one or more of a cationic ethoxylated alcohol including a quaternary ammonium cation, a cationic polymerized polyglucoside, a block copolymer of ethylene oxide and propylene oxide, a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid.

In some embodiments, a method of drilling a borehole includes drilling a borehole in an earth formation using a drilling fluid comprising a base fluid and a wettability modifier. The base fluid includes water and salt. The wettability modifier includes one or more of a cationic ethoxylated alcohol including a quaternary ammonium cation, a cationic polymerized polyglucoside, a block copolymer of ethylene oxide and propylene oxide, a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid. The method further includes exposing the wettability modifier to one or more conditions within the borehole to impart hydrophobic properties on the wettability modifier, and contacting surfaces of the earth formation with the wettability modifier to form oil-wet surfaces on the earth formation.

In some embodiments, a drilling fluid includes an aqueous base fluid including water and salt. The drilling fluid further includes a temperature-responsive wettability modifier including one or more of a cationic ethoxylated alcohol including a quaternary ammonium cation, a cationic polymerized polyglucoside, and a block copolymer of ethylene oxide and propylene oxide. The wettability modifier further includes a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a drilling system for drilling an earth formation to form a wellbore, according to at least one embodiment of the present disclosure;

FIG. 2 illustrates a general structure of a cationic ethoxylated alcohol that may be used in a wettability modifier, according to at least one embodiment of the disclosure;

FIG. 3 illustrates a general structure of a cationic polymerized alkyl polyglucoside that may be used in a wettability modifier, according to at least one embodiment of the disclosure;

FIG. 4 illustrates a general structure of a cationic polymerized alkyl polyglucoside that may be used in a wettability modifier, according to at least one embodiment of the disclosure;

FIG. 5 illustrates a general structure of a block copolymer of ethylene oxide and propylene oxide that may be used in a wettability modifier, according to at least one embodiment of the disclosure;

FIG. 6 illustrates a general structure of a polymer that may be used in a wettability modifier, according to at least one embodiment of the present disclosure;

FIG. 7 illustrates a general structure of another polymer that may be used in a wettability modifier, according to at least one embodiment of the present disclosure;

FIG. 8 illustrates a general structure of yet another polymer that may be used in a wettability modifier, according to at least one embodiment of the present disclosure; and

FIG. 9 is a simplified flow diagram illustrating a method of drilling a borehole, according to at least one embodiment of the disclosure.

### DETAILED DESCRIPTION

This disclosure generally relates to devices, systems, and methods for drilling a borehole or wellbore in a subterranean earth formation (also referred to as an “earth formation”), and to related drilling fluids or other wellbore fluids for drilling the borehole. The drilling fluid may be an aqueous-based drilling fluid and include a wettability modifier. In some embodiments, the drilling fluid is a drill-in fluid (also referred to as “reservoir drill-in fluid” (RDF)). In addition to drilling fluids, the wettability modifier may be used in different wellbore fluids, such as workover fluids, spacer fluids (e.g., a fluid introduced into the wellbore after a drilling fluid and prior to a cement composition to flush residual drilling fluid from the annulus), stimulation fluids, or other wellbore fluids. The drilling fluid including the wettability modifier may be used during drilling of a wellbore or borehole for producing hydrocarbons, for storing hydrocarbons, or for forming other types of wellbores. The drilling fluid including the wettability modifier is not limited to the particular type of borehole or wellbore being drilled.

The wettability modifier may be formulated and configured to alter a wettability of surfaces of the earth formation. In some embodiments, the wettability modifier is configured to interact with water-wet earth formations and change the wettability of the earth formation from water-wet to oil-wet. The wettability modifier may be configured to interact with surfaces of the earth formation through cationic exchange, temperature-induced hydrophobic interaction, and/or salt-induced hydrophobic interaction with the earth formation. Modifying (e.g., altering, changing) the surfaces of the earth formation from water-wet to oil-wet may form hydrophobic surfaces on the earth formation. The oil-wet surfaces may repel the aqueous-based drilling fluid, reducing the infiltration (e.g., imbibition) of the aqueous-based fluid into the earth formation. For example, the oil-wet surfaces may form hydrophobic surfaces on the earth formation, increasing the capillary pressure of aqueous-based fluids in pores defined by the hydrophobic surface and reducing the imbibition of the aqueous-based fluids by the earth formation.

The wettability modifier may be provided to the earth formation and/or the borehole with an aqueous-based drilling fluid. The wettability modifier may include a surfactant, a polymer, or both, each of which may be formulated and configured to interact with water-wet surfaces of the earth formation and change the wettability of the surfaces from water-wet to oil-wet. In some embodiments, responsive to exposure to one or more conditions within the earth formation or the borehole (e.g., a threshold salinity, a threshold temperature), the wettability modifier may exhibit hydrophobic properties.

The wettability modifier may include a polymer (e.g., a copolymer, a terpolymer) and/or a surfactant having a cationic head and a hydrophobic tail. In some embodiments, the wettability modifier is configured to interact with the water-wet surfaces of the earth formation through cationic exchange. For example, a cationic head of the wettability modifier may interact with water-wet surfaces of the earth formation (e.g., cations on the water-wet surfaces of the earth formation) and replace cations of the water-wet surfaces with cations of the wettability modifier. Interaction of the wettability modifier with the earth formation may cause a hydrophilic portion (e.g., a hydrophilic head) of the wettability modifier to attach to the surfaces of the earth formation and a hydrophobic portion (e.g., a hydrophobic tail) to be exposed and stick out from the surfaces of the earth formation. The hydrophobic tails of the wettability modifier may impart hydrophobic properties of the surfaces of the earth formation. Accordingly, responsive to interaction with the water-wet surfaces of the earth formation, the hydrophobic portions of the wettability modifier may be exposed on the surfaces of the earth formation, altering the wettability of the earth formation from water-wet to oil-wet (due to the hydrophobic nature of the tail groups sticking out from the surfaces of the earth formation).

The wettability modifier may include one or both of a surfactant or a polymer. The surfactant may include, for example, a cationic ethoxylated alcohol, a poly(ethyleneoxide)/poly(propyleneoxide) copolymer, one or more cationic polymerized alkyl polyglycosides, another surfactant, or combinations thereof. The polymer may include, for example, a polymer of one or both of N-isopropylacrylamide (NIPAM) or N,N-diethylacrylamide and one or both of acrylamide or 2-acrylamido-2-methylpropane sulfonic acid (AMPS; also referred to as 2-acrylamide-2-methyl-1-propanesulfonic acid). The polymer may include a copolymer, a terpolymer, or another polymer.

The wettability modifier may be formulated and configured to be soluble and/or dispersible in the drilling fluid, such as aqueous-based drilling fluids. For example, the wettability modifier may be formulated and configured to be soluble and/or dispersible in the aqueous phase of the drilling fluid, facilitating delivery of the wettability modifier to the earth formation with the drilling fluid. In some embodiments, the wettability modifier includes at least a hydrophilic portion to facilitate the solubility of the wettability modifier in the aqueous-based drilling fluid.

The wettability modifier may be formulated and configured to exhibit hydrophobicity responsive to exposure to one or more conditions within the borehole and/or earth formation. In some embodiments, the wettability modifier includes a material exhibiting one or both of temperature-induced hydrophobicity or salt-induced hydrophobicity. In some embodiments, the wettability modifier is formulated and configured to interact with the surfaces of the earth formation via interaction of the cationic portion of the wettability modifier with water-wet surfaces of the earth formation.

The oil-wet nature of the surfaces of the earth formation may reduce the amount (e.g., the volume) of the aqueous phase of the aqueous-based drilling fluid that is imbibed by the earth formation. Accordingly, changing the surfaces of the earth formation to oil-wet may improve the stability of the earth formation and the borehole, and may reduce the amount of the aqueous-based drilling fluid that infiltrates into the earth formation.

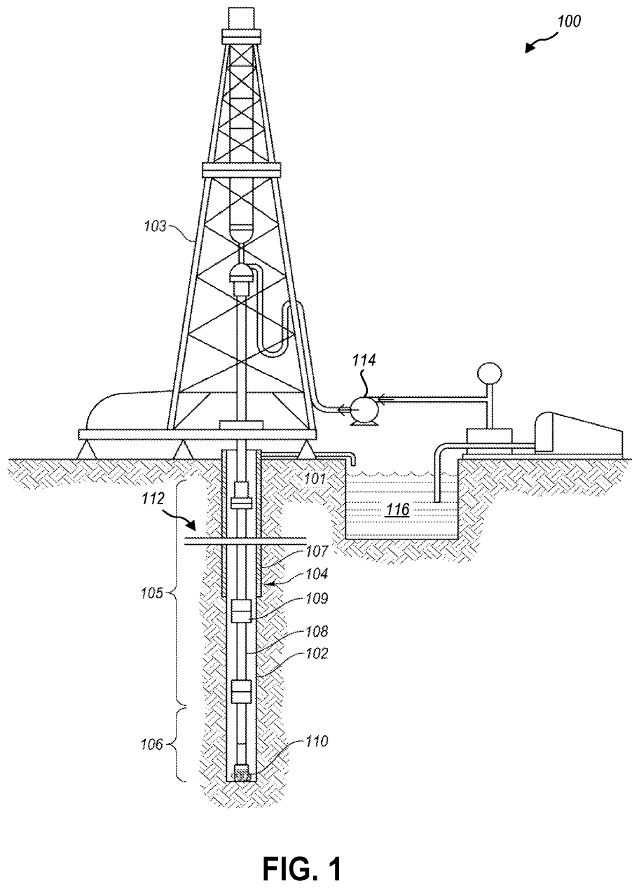

FIG. 1 shows one example of a drilling system 100 for drilling an earth formation 101 to form a borehole 102 defining a wellbore 112. The drilling system 100 includes a drill rig 103 used to turn a drilling tool assembly 104 which extends downward into the borehole 102 and/or wellbore 112. The drilling tool assembly 104 may include a drill string 105, a bottomhole assembly (“BHA”) 106, and a bit 110, attached to the downhole end of drill string 105. The wellbore 112 may be used to facilitate one or more of hydrocarbon recovery from the earth formation 101, carbon storage in the earth formation 101 (such as by injection of carbon dioxide into the earth formation 101), injection of other fluids into the earth formation 101, stimulation of geological formations for hydrogen generation and/or carbon dioxide storage, or other processes.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the borehole 102 or wellbore 112 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore 112. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 112. The bit 110 may also be a junk mill used to mill away tools, plugs, cement, other materials within the borehole 102, or combinations thereof. Swarf or other cuttings formed by use of a mill may be lifted to the surface, or may be allowed to fall downhole.

During drilling operations, a drilling fluid may be used to facilitate lubrication and cooling of the bit 110 and removal of cuttings of the earth formation 101 from the borehole 102 and/or wellbore 112. The drilling fluid may be configured to be circulated through the drill string 105, out of the drill string 105 through the bit 110, and into the annulus between the drill string 105 and the surfaces of the earth formation 101 defining the borehole 102 (or the wellbore 112). For example, a surface pump 114 may pump the drilling fluid from a mud pit 116 which holds the drilling fluid. In some embodiments, one or more additives may be added to the drilling fluid, such as by providing the one or more additives to the mud pit 116.

The drilling fluid may include one or more materials formulated and configured to facilitate drilling of the earth formation 101. In addition, the drilling fluid may include a wettability modifier formulated and configured to form oil-wet surfaces on surfaces of the earth formation 101, such as surfaces of the earth formation 101 defining the borehole 102. As described herein, the wettability modifier may include one or more materials that, responsive to exposure to one or more conditions within the borehole 102, wellbore 112, and/or earth formation 101, interact with surfaces of the earth formation 101 and modify (e.g., alter, change) the wettability of the earth formation 101 to oil-wet (e.g., from water-wet to oil-wet, from a mixed wettability condition to a more oil-wet condition). Modifying the wettability of the earth formation 101 to oil-wet may reduce the interaction of the aqueous phase of the drilling fluid with the earth formation 101 and may reduce fluid losses of the drilling fluid within the earth formation 101, reducing damage to the earth formation 101 caused by the drilling fluid.

The drilling fluid may include a base fluid, the wettability modifier, and one or more additives. The one or more additives may include one or more of bridging materials, viscosifiers, fluid loss materials, thinners (e.g., dispersion aids), weighting materials, filtration control agents, shale stabilizers, pH buffers, emulsifiers, corrosion inhibitors, emulsion activators, gelling agents, shale inhibitors, defoamers, additional surfactants, foaming agents, scale inhibitors, solvents, rheological additives, or other additives.

In some embodiments, the drilling fluid includes an aqueous-based drilling fluid and may be referred to as a “drilling mud.” The base fluid may include water, sea water, brine, or a salt-containing aqueous solution. By way of non-limiting example, the base fluid may include a brine including water and one or more salts (e.g., one or more organic salts and/or one or more inorganic salts).

The one or more salts may provide a desired density to the drilling fluid, reduce the effect of the drilling fluid on hydratable clays and shales the earth formation 101, and/or reduce (e.g., prevent) gas hydrate formation. The salts may include salts of one or more of sodium, calcium, aluminum, magnesium, zinc, potassium, strontium, or lithium, and salts of one or more of chlorides, bromides, carbonates, iodides, chlorates, bromates, formates, nitrates, oxides, phosphates, sulfates, silicates, or fluorides. In some embodiments, the salt comprises a divalent halide, such as an alkaline earth halide (e.g., calcium chloride (CaCl₂), calcium bromide (CaBr₂)), or a zinc halide. The salt may include cesium formate (HCOOCs), sodium bromide (NaBr), potassium bromide (KBr), and cesium bromide (CsBr). The particular composition of the salt may be selected based on compatibility with the earth formation 101 and/or to match the brine phase of a completion fluid.

The salt may constitute from about 0.0 weight percent (e.g., such as when the base fluid comprises fresh water) to about 50.0 weight percent of the drilling fluid, such as from about 0.0 weight percent to about 5.0 weight percent, from about 5.0 weight percent to about 10.0 weight percent, from about 10.0 weight percent to about 20.0 weight percent, from about 20.0 weight percent to about 30.0 weight percent, from about 30.0 weight percent to about 40.0 weight percent, or from about 40.0 weight percent to about 50.0 weight percent of the drilling fluid. However, the disclosure is not so limited, and the weight percent of the salt and the water in the drilling fluid may be different than that described.

As described above, the drilling fluid may include a wettability modifier formulated and configured to modify (alter) a wettability of the earth formation 101, such as during drilling operations and/or circulation of the drilling fluid through the borehole 102 and/or wellbore 112. For example, the wettability modifier may be formulated and configured to interact with water-wet surfaces of the earth formation 101, such as by one or more of cationic exchange, temperature-induced hydrophobic interaction, and/or salt-induced hydrophobic interaction with the earth formation. In some embodiments, responsive to interacting with the surfaces of the earth formation 101, the wettability modifier may form hydrophobic surfaces on at least some surfaces of the earth formation 101. For example, the wettability modifier may form oil-wet surfaces within the earth formation 101. The oil-wet surfaces may repel the aqueous-based drilling fluid and reduce the infiltration of the aqueous-based drilling fluid into the earth formation 101. For example, the hydrophobic surfaces may reduce the amount of the drilling fluid that is imbibed by pores of the earth formation 101.

The wettability modifier may include one or both of a surfactant or a polymer, each of which may be formulated and configured to interact with water-wet surfaces of the earth formation 101 and modify the wettability of the surfaces from water-wet to oil-wet and/or to mixed wettability. The wettability modifier may include a hydrophobic portion and a hydrophilic portion. In some embodiments, the hydrophobic portion includes one or more cations, such as a tertiary amine or a quaternary ammonium. The hydrophilic portion may attach to the surfaces of the earth formation 101 by one or more of cationic exchange, cationic bridging, hydrogen bonding, van der Waals forces, or other mechanisms.

The wettability modifier may include one or more of a cationic ethoxylated alcohol, a cationic polymerized polyglucoside, a block copolymer of ethylene oxide and propylene oxide (e.g., a poly(ethyleneoxide)/poly(propyleneoxide) triblock copolymer, a polymer of N-isopropylacrylamide and at least one of acrylamide or AMPS, or a polymer of diethylacrylamide and at least one of acrylamide or AMPS.

In some embodiments, the wettability modifier includes a surfactant including a hydrophilic head and a hydrophobic tail. The surfactant may include, for example, a cationic ethoxylated alcohol, a cationic polymerized alkyl polyglucoside, a block copolymer of ethylene oxide and propylene (also referred to as a poly(ethyleneoxide)/poly(propyleneoxide) copolymer (e.g., a poly(ethyleneoxide)/poly(propyleneoxide) triblock copolymer), a “pluronic,” an “EO/PO” polymer), another cationic surfactant, or combinations thereof.

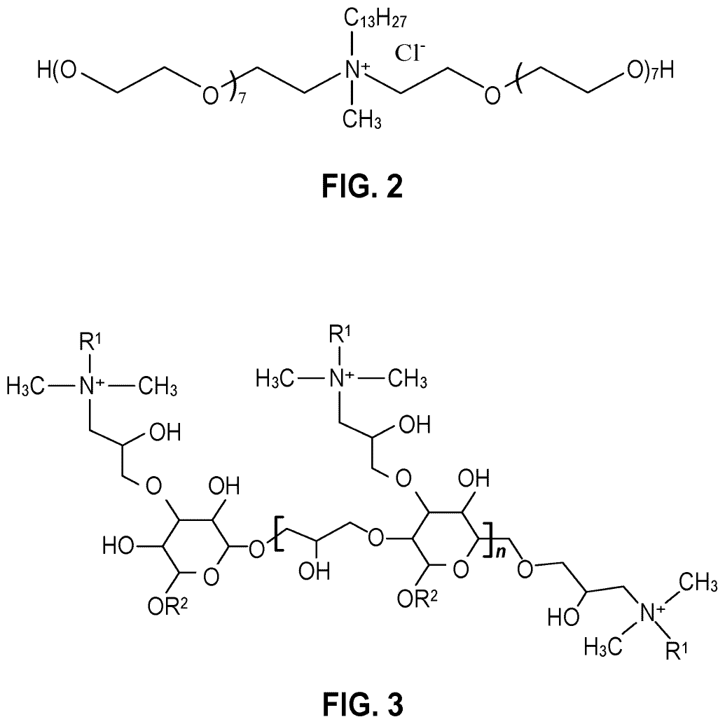

In some embodiments, the wettability modifier includes a cationic ethoxylated alcohol. For example, the cationic ethoxylated alcohol may include a quaternary ammonium compound, wherein the nitrogen atom is bonded to a methyl group, two ethoxylated alcohol groups, and an alkyl group (such as a tridecane (—C₁₃H₂₇) group)). The cationic ethoxylated alcohol may include cocoalkylmethyl[polyoxyethylene (15)] ammonium chloride commercially available from Nouryon Specialty Chemicals B.V. of Amsterdam, Netherlands under the tradename Ethoquod® C/25. The cationic ethoxylated alcohol may have the general structure illustrated in structure (I) below, which is also illustrated in FIG. 2:

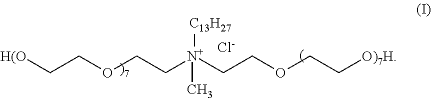

In other embodiments, the cationic ethoxylated alcohol includes ethoxylated alcohols including a different number of ethylene oxide groups. In some embodiments, each of the ethoxylated alcohol groups may include different than seven (e.g., less than, more than) ethylene oxide groups. In some embodiments, and as shown in structure (I), the ethoxylated alcohols groups bonded to the nitrogen atom have the same number of ethylene oxide groups. In some embodiments, the ethoxylated alcohol groups bonded to the nitrogen atom include a different number of ethylene oxide groups than one another.

In some embodiments, the wettability modifier includes a cationic polymerized alkyl polyglucoside (also referred to as a “polyglycoside”). The cationic polymerized alkyl polyglucoside may include one or more quaternary ammonium groups (quaternary ammonium cations). The polyglucoside may include repeating units of an alkyl-substituted glucose bonded to another functional group via a glycosidic bond (an ether bond between the alkyl-substituted glucose and the another functional group). The another functional group may include an amine group, such as a tertiary amine, and may include an alkanolamine (amino alcohol). The amine groups of the cationic polymerized alkyl polyglucoside may be cationic and formulated and configured to interact with the water-wet surfaces of the earth formation 101. In addition, the cationic groups may facilitate the solubility of the cationic polymerized alkyl polyglucoside in the drilling fluid. Each tertiary amine group may be bonded to two methyl groups and to an alkyl group including one of a lauryl group, a stearyl group, or another methyl group. The alkyl groups of the alkyl-substituted glucose may include one or more of a decyl group (—C₁₀H₂₁), a lauryl group (—C₁₂H₂₅), or a coco group (—C₁₁H₂₃) and may be bonded to the glucose unit by means of an ether linkage.

In some embodiments, the cationic polymerized alkyl polyglucoside may have the general structure shown in structure (II) below, which is also shown in FIG. 3:

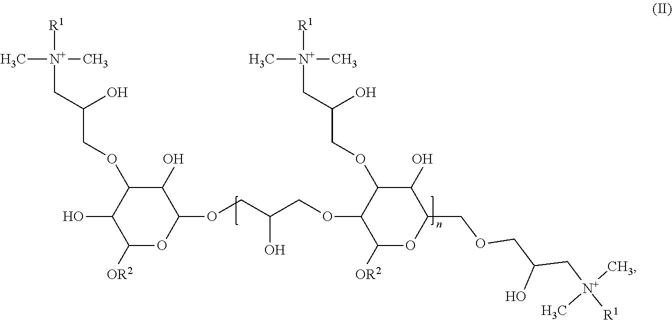

wherein R¹ includes one or more of a lauryl group, a stearyl group (—C₁₈H₃₇), or a methyl group; R² includes one or more of a decyl group, a lauryl group, or a coco group; and n is selected such that the number average molecular weight (Mn) of the polymer is less than about 15,000 g/mol. In some embodiments, the R¹ groups are the same as one another throughout the cationic polymerized alkyl polyglucoside. In addition, each of the R² groups may be the same throughout the cationic polymerized alkyl polyglucoside. In some embodiments, R¹ and R² are different than one another. In other embodiments, R¹ and R² are the same as one another. In some embodiments, the cationic polymerized alkyl polyglucoside includes Poly Suga®Quat S-1210P, commercially available from Colonial Chemical of South Pittsburg, Tennessee.

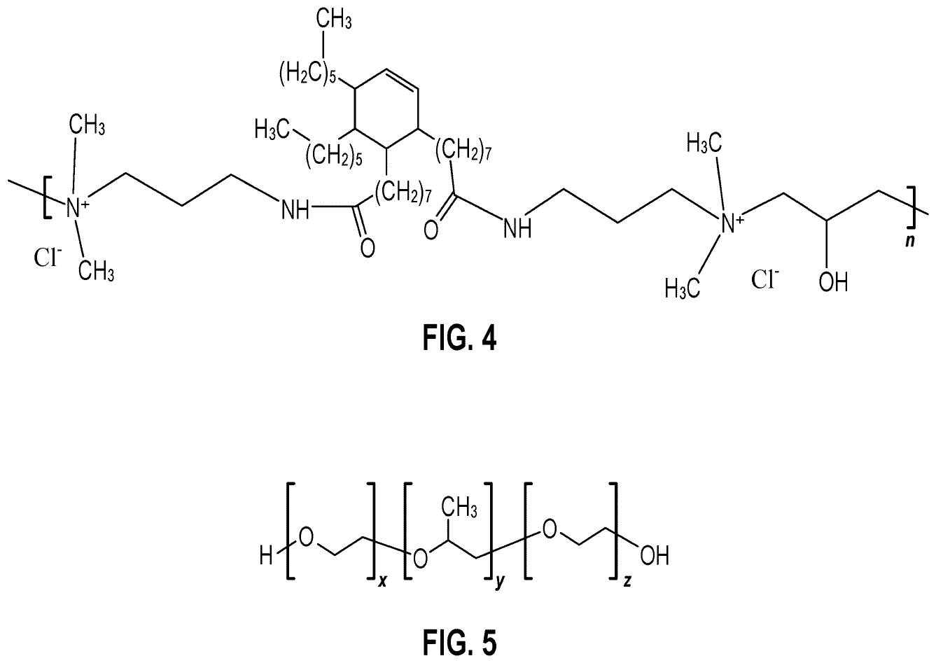

In other embodiments, the cationic polymerized alkyl polyglucoside includes a polyquat (a polyquaternium including a cationic polymer) based on a naturally-derived dimer acid from safflower oil. The cationic polymerized alkyl polyglucoside may include the following structure shown in structure (III) below, and also shown in FIG. 4:

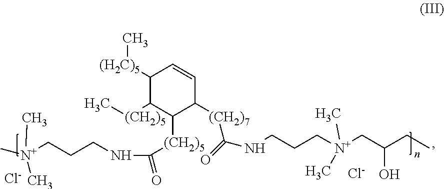

wherein n is selected such that the cationic polymerized alkyl polyglucoside has a number average molecular weight Mn less than 100,000 g/mol. The number average molecular weight may be selected such that the wettability modifier exhibits a desired viscosity. The number average molecular weight may be within a range of from about 5,000 g/mol to about 100,000 g/mol, such as from about 5,000 g/mol to about 10,000 g/mol, from about 10,000 g/mol to about 20,000 g/mol, from about 20,000 g/mol to about 40,000 g/mol, from about 40,000 g/mol to about 60,000 g/mol, from about 60,000 g/mol to about 80,000 g/mol, or from about 80,000 g/mol to about 100,000 g/mol. In some embodiments, the cationic polymerized alkyl polyglucoside includes Cola®Quat PDQ, commercially available from Colonial Chemical of South Pittsburg, Tennessee.

The wettability modifier may include a block copolymer of ethylene oxide and propylene oxide. For include example, the wettability modifier may a surfactant, such as a poly(ethyleneoxide)/poly(propyleneoxide) poly(ethyleneoxide)/poly(propyleneoxide) triblock copolymer. By way of non-limiting example, the wettability modifier may have the general structure shown in structure (IV) below, as also shown in FIG. 5:

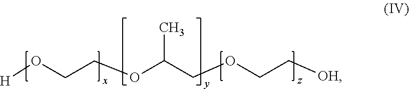

wherein x, y, and z are selected such that the number average molecular weight of the wettability modifier is within a range of from about 1,000 g/mol to about 100,000 g/mol, such as from about 1,000 g/mol to about 2,000 g/mol, from about 2,000 g/mol to about 5,000 g/mol, from about 5,000 g/mol to about 10,000 g/mol, from about 10,000 g/mol to about 20,000 g/mol, from about 20,000 g/mol to about 40,000 g/mol, from about 40,000 g/mol to about 60,000 g/mol, from about 60,000 g/mol to about 80,000 g/mol, or from about 80,000 g/mol to about 100,000 g/mol. In some embodiments, the number average molecular weight of the wettability modifier block copolymer of ethylene oxide and propylene oxide is less than about 100,000 g/mol. As shown in structure (IV), the block copolymer of ethylene oxide and propylene oxide may include a general structure of poly(ethyleneoxide)-poly(propyleneoxide)-poly(ethyleneoxide). The poly(propyleneoxide) core may be hydrophobic, and the poly(ethyleneoxide) chains (at the terminal end of the wettability modifier) may be hydrophilic. The poly(ethyleneoxide) chains may be formulated and configured to interact with (e.g., attach to) the surface of the earth formation 101, while the poly(propyleneoxide) remains exposed to impart hydrophobic properties to the surfaces of the earth formation 101.

In some embodiments, x and z may be substantially the same. In other embodiments, x and z are different. In some embodiments, y is greater than each of x and z. The molecular weight (e.g., the number average molecular weight) of the wettability modifier depend on the values of x, y, and z.

In some embodiments, the wettability modifier includes a polymer. The wettability modifier may include a polymer of N-isopropylacrylamide or diethylacrylamide and one or both of acrylamide or AMPS. For example, the polymer may include one or more of a copolymer of N-isopropylacrylamide and acrylamide, a copolymer of N-isopropylacrylamide and AMPS, a terpolymer of N-isopropylacrylamide, acrylamide, and AMPS, a copolymer of diethylacrylamide and acrylamide, a copolymer of diethylacrylamide and AMPS, or a terpolymer of diethylacrylamide, acrylamide, and AMPS. In some embodiments, the wettability modifier includes a polymer (e.g., a copolymer) of N-isopropylacrylamide or diethylacrylamide and one or more monomers, such as one or more of acrylamide, unsubstituted acrylamide, methacrylamide, N-substituted acrylamides (e.g., alkylacrylamides, N-methylolacrylamide, N-isopropylacrylaminde, diacetone acrylamide, N-alkyl acrylamide (where alkyl is C₁ to C₁₄), and N,N-dialkyl acrylamides (where alkyl is C₁ (e.g., N,N-diemethylacrylamide) to C₁₄), N-cycloalkane acrylamides, N-(2-hydroxyethyl) acrylamide, N-isopropyl acrylamide, N-[3-(dimethylamino)propyl] acrylamide), N-substituted methacrylamides, acrylates, metacrylates, acryloylmorpholine (e.g., 4-acryloylmorpholine), acrylic acid, methacrylic acid, N-vinylamides, N-allyl amides, vinyl alcohol, vinyl ethers, vinyl esters, allyl alcohol, allyl ethers, allyl esters, acrylic esters, methacrylic esters, N-vinylformamide, N-vinyl acetamide, N-vinylpyridine, N-vinylpyrrolidone, one or more sulfonated anionic monomers (e.g., one or more of 2-acrylamide-2-methyl-propanesulfonic acid (AMPS®), a trademark of the Lubrizol Corporation (also referred to as acrylamide tertiary butyl sulfonic acid (ATBS)), vinyl sulfonates, styrene sulfonic acid), allyl sulfonates, vinylimidazole, allylimidazole, diallyldimethylammonium chloride, methyl chloride quaternary, lipophilic monomers (e.g., one or more of isobornyl methacrylate, 2-ethyl hexyl acrylate, N-alkyl and N,N-dialkyl acrylamide, and styrene), one or more anionic monomers (e.g., one or more of maleic acid, tetrahydrophthalic acid, fumaric acid, acrylic acid), and N-vinyl lactams.

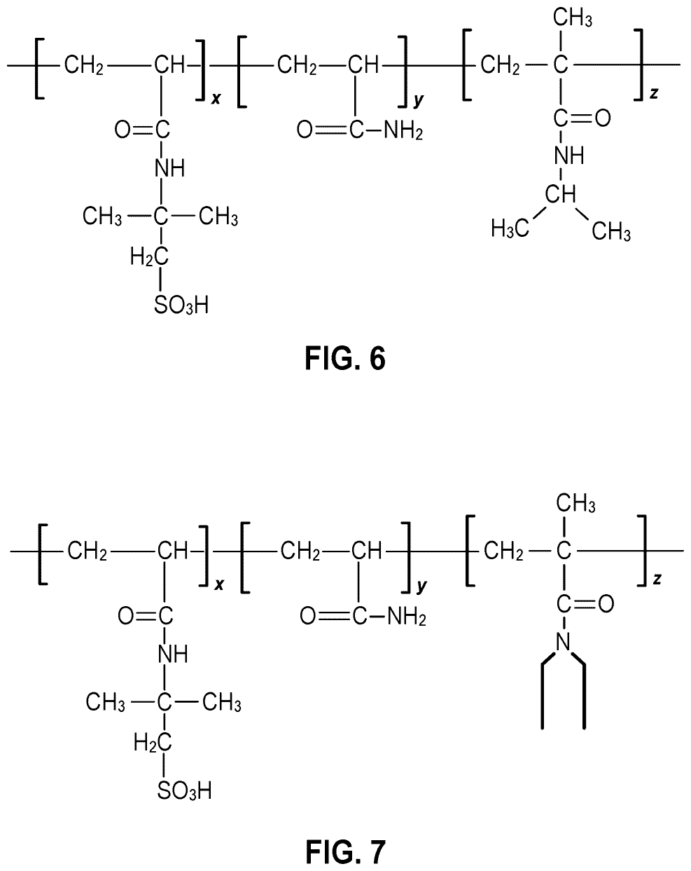

In some embodiments, the polymer includes a copolymer or terpolymer of N-isopropylacrylamide and one or both of acrylamide or AMPS, and may have the general structure of structure (V) below, which is also shown in FIG. 6:

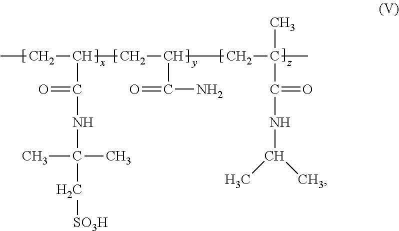

wherein x, y, and z are selected such that the number average molecular weight of the polymer is within a range of from about 1,000 g/mol to about 1,000,000 g/mol. In structure (V), x corresponds to the amount of AMPS, y corresponds to the amount of the acrylamide, and z corresponds to the amount of the N-isopropylacrylamide. Where the polymer includes a copolymer of N-isopropylacrylamide and only one of AMPS or acrylamide, one of x and y is equal to 0. For example, where the wettability modifier includes a copolymer of acrylamide and N-isopropylacrylamide, x may be equal to 0; and where the wettability modifier includes a copolymer of AMPS and N-isopropylacrylamide, y may be equal to 0.

In structure (V), the backbone of the polymer may be formed of and include primarily the N-isopropylacrylamide and may include from about 50 percent to about 90 percent (by number of monomer units) N-isopropylacrylamide. A value of z may be greater than a sum of the value of x and y. In other words, the polymer may include a greater number of units of the N-isopropylacrylamide monomer than of the total units of the acrylamide monomer and the AMPS monomer. By way of non-limiting example, a ratio of z to the sum of x, y, and z (the total of x, y, and z) may be within a range of from about 0.50:1.0 to about 0.90:1.0, such as from about 0.50:1.0 to about 0.60:1.0, from about 0.60:1.0 to about 0.70:1.0, from about 0.70:1.0 to about 0.80:1.0, or from about 0.80:1.0 to about 0.90:1.0, or from about 0.90:1.0 to about 1.0:1.0. Accordingly, greater than about 50 percent, such as greater than about 60 percent, greater than about 70 percent, greater than about 80 percent, or even greater than about 90 percent of the monomer units of the polymer may include N-isopropylacrylamide. A ratio of the sum of x and y to the sum of x, y, and z may be within a range of from about 0.10:1.0 to about 0.50:1.0, such as from about 0.10:1.0 to about 0.20:1.0, from about 0.20:1.0 to about 0.30:1.0, from about 0.30:1.0 to about 0.40:1.0, or from about 0.40:1.0 to about 0.50:1.0. Accordingly, from about 10 percent to about 50 percent of the monomer units of the polymer may include acrylamide and/or AMPS.

In some embodiments, the polymer includes a polymer of diethylacrylamide and one or both of acrylamide or AMPS. The polymer may include a copolymer of diethylacrylamide and acrylamide, a copolymer of diethylacrylamide and AMPS, or a terpolymer of diethylacrylamide, acrylamide, and AMPS. In some embodiments, the polymer includes a copolymer or terpolymer of diethylacrylamide and one or both of acrylamide or AMPS and may have the general structure of structure (VI) below, which is also shown in FIG. 7:

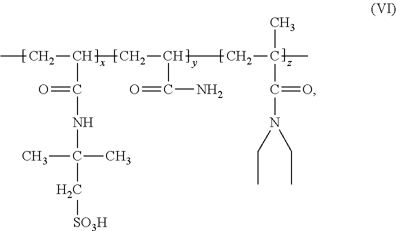

wherein x, y, and z are selected such that the number average molecular weight of the polymer is within a range of from about 1,000 g/mol to about 1,000,000 g/mol. The values and ratios of x, y, and z may be substantially the same as that described above with reference to the polymer of structure V. In some embodiments, the backbone of the polymer may be formed of and include primarily the diethylacrylamide, and may include from about 50 percent to about 90 percent (by number of monomer units) diethylacrylamide.

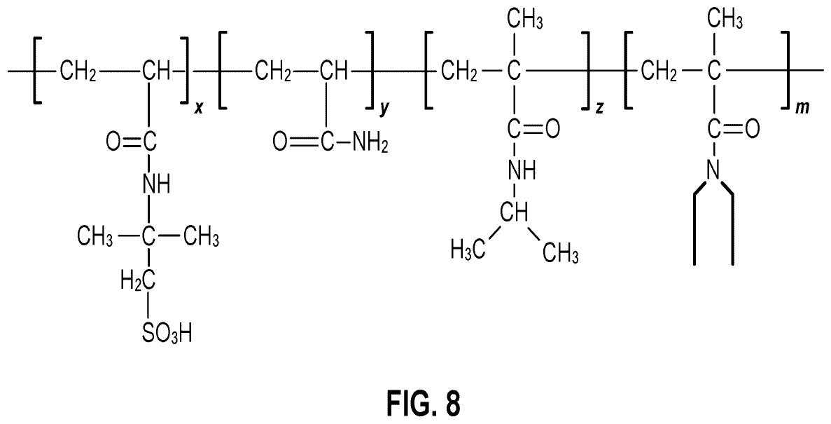

In some embodiments, the wettability modifier includes a polymer of N-isopropylacrylamide and diethylacrylamide and at least one of acrylamide or AMPS. In some embodiments, the polymer includes a terpolymer of N-isopropylacrylamide, diethylacrylamide, and acrylamide. In some embodiments, the polymer includes a terpolymer of N-isopropylacrylamide, diethylacrylamide, and AMPS. In some embodiments, the polymer includes a polymer of N-isopropylacrylamide, diethylacrylamide, acrylamide, and AMPS. For example, the polymer includes a polymer of diethylacrylamide, N-isopropylacrylamide, acrylamide, and AMPS and may have the general structure of structure (VII) below, which is also shown in FIG. 8:

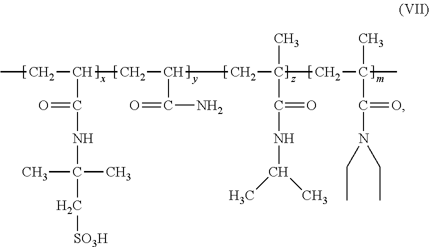

wherein x, y, z, and m are selected such that the number average molecular weight of the polymer is within a range of from about 1,000 g/mol to about 1,000,000 g/mol.

A number average molecular weight of the polymer may be within a range of from about 1,000 g/mol to about 1,000,000 g/mol, such as from about 1,000 g/mol to about 2,000 g/mol, from about 2,000 g/mol to about 5,000 g/mol, from about 5,000 g/mol to about 10,000 g/mol, from about 10,000 g/mol to about 25,000 g/mol, from about 25,000 g/mol to about 50,000 g/mol, from about 50,000 g/mol to about 100,000 g/mol, from about 100,000 g/mol to about 200,000 g/mol, from about 200,000 g/mol to about 300,000 g/mol, from about 300,000 g/mol to about 500,000 g/mol, or from about 500,000 g/mol to about 1,000,000 g/mol.

As described above, the polymer may include a greater number of units of the N-isopropylacrylamide and/or the diethylacrylamide than units of the acrylamide and/or AMPS. In some embodiments, the acrylamide and/or AMPS in the polymer may facilitate solubility of the polymer in the aqueous phase, while the N-isopropylacrylamide and/or the diethylacrylamide may exhibit hydrophobic properties.

In some embodiments, the wettability modifier includes a surfactant including one or both of the cationic ethoxylated alcohol, cationic polymerized alkyl polyglucoside, or the block copolymer of ethylene oxide and propylene oxide; and one or more of the polymers described above. In some embodiments, the wettability modifier includes the surfactant and the polymer. In embodiments wherein the wettability modifier includes the surfactant and the polymer, the surfactant may constitute from about 10.0 weight percent to about 90.0 weight percent of the wettability modifier, such as from about 10.0 weight percent to about 20.0 weight percent, from about 20.0 weight percent to about 30.0 weight percent, from about 30.0 weight percent to about 50.0 weight percent, from about 50.0 weight percent to about 70.0 weight percent, or from about 70.0 weight percent to about 90.0 weight percent of the wettability modifier. In addition, the polymer may constitute from about 10.0 weight percent to about 90.0 weight percent of the wettability modifier, such as from about 10.0 weight percent to about 20.0 weight percent, from about 20.0 weight percent to about 30.0 weight percent, from about 30.0 weight percent to about 50.0 weight percent, from about 50.0 weight percent to about 70.0 weight percent, or from about 70.0 weight percent to about 90.0 weight percent of the wettability modifier. In some embodiments, the wettability modifier includes about 1.0 part of the surfactant for every about 1.0 part of the polymer.

The surfactant may constitute from about 1.0 volume percent to about 5.0 volume percent of the drilling fluid, such as from about 1.0 volume percent to about 2.0 volume percent, from about 2.0 volume percent to about 3.0 volume percent, from about 3.0 volume percent to about 4.0 volume percent, or from about 4.0 volume percent to about 5.0 volume percent of the drilling fluid.

The polymer may constitute from about 1.0 volume percent to about 5.0 volume percent of the drilling fluid, such as from about 1.0 volume percent to about 2.0 volume percent, from about 2.0 volume percent to about 3.0 volume percent, from about 3.0 volume percent to about 4.0 volume percent, or from about 4.0 volume percent to about 5.0 volume percent of the drilling fluid.

In some embodiments, the wettability modifier may be formulated and configured to interact with water-wet (or hydrophilic) surfaces of the earth formation 101 via cationic exchange or other mechanisms. In some embodiments, the wettability modifier is formulated and configured to exhibit hydrophobic properties responsive to exposure to salt in the drilling fluid and/or the borehole 102, the wellbore 112, and/or the earth formation 101, or responsive to exposure to a predetermined temperature in the drilling fluid and/or the borehole 102, the wellbore 112, and/or the earth formation 101. By way of non-limiting example, the wettability modifier may include a salt-sensitive surfactant or polymer and/or a temperature-sensitive surfactant and/or polymer. In some embodiments, the salt-sensitive surfactant or polymer and/or a temperature-sensitive surfactant and/or polymer may interact with (e.g., attach to) hydrophilic surfaces of the earth formation 101, such as a reactive clay in the earth formation 101 (e.g., such as a bentonite earth formation). Responsive to attachment of the surfactant and/or polymer to the surfaces of the earth formation 101, the earth formation 101 may be oil-wet and exhibit hydrophobic properties. In some embodiments, the wettability modifier includes a temperature-sensitive (or a temperature-responsive) material formulated and configured to modify the wettability of the earth formation 101 responsive to exposure to a threshold temperature (e.g., downhole, such as within the borehole 102, the wellbore 112, and/or the earth formation 101).

Without being bound by any particular theory, it is believed that responsive to exposure to salt (such as in the drilling fluid) and temperatures within the borehole 102, wellbore 112, and/or earth formation 101, the wettability modifier may exhibit hydrophobic properties. It is believed that the salinity of the drilling fluid at the temperatures encountered downhole may disrupt the hydrogen bonding between water in the aqueous phase of the drilling fluid and the wettability modifier (such as by promoting ion-dipole interactions), reducing the solubility of the wettability modifier in the aqueous phase, causing the wettability modifier to exhibit hydrophobic properties. By way of non-limiting example, the wettability modifier may exhibit hydrophobic properties responsive to exposure to a temperature greater than about 37.8° C. (about 100° F.), such as greater than about 50° C. (about 122° F.), greater than about 75° C. (about 167° F.), or greater than about 100° C. (about 212° F.).

As described above, the drilling fluid may further include one or more additives selected based on the desired properties of the drilling fluid. As discussed above, and by way of non-limiting example, the one or more additional additives may include one or more of bridging materials, viscosifiers, fluid loss materials, thinners, weighting materials, filtration control agents, shale stabilizers, pH buffers, emulsifiers, corrosion inhibitors, emulsion activators, gelling agents, shale inhibitors, defoamers, additional surfactants, foaming agents, scale inhibitors, solvents, rheological additives, or other additives that may be suitable depending on the particular operation.

The bridging material may include particles of at least one of calcium carbonate, zinc carbonate, barium carbonate, a coated metal oxide (e.g., hemalite, ilmenite, magnesium oxide), dolomite (calcium magnesium carbonate), colemanite, ulexite, analcite, apatite, bauxite, brucite, gibbsite, hydrotalcite, galena, hematite, magnetite, iron oxides, siderite, celestite, magnesium citrate, calcium citrate, calcium succinate, calcium maleate, calcium tartrate, magnesium tartrate, bismuth citrate, other suspended salts, mica, nutshells, or fibers. The bridging materials may be hydrophobically coated with one or more hydrophobic functional groups.

Viscosifiers of the drilling fluid may include a material formulated and configured to increase the viscosity of the drilling fluid and, optionally, to facilitate formation of a filtercake between the earth formation 101 and one or more of (e.g., each of) the drill string 105, casing 107, and liners. The viscosifier may include, for example, a polymer (e.g., a copolymer) formed from at least one acrylamide monomer and at least one sulfonated anionic monomer. In other words, the viscosifier may include a reaction product of the at least one acrylamide monomer and at least one sulfonated anionic monomer. In other embodiments, the first component comprises a higher order copolymer and/or block copolymers, such as a terpolymer, a quaternary polymer, or another higher order polymer including the at least one acrylamide monomer and the at least one sulfonated anionic monomer.

The at least one acrylamide monomer may include one or more of acrylamide, unsubstituted acrylamide, methacrylamide, N-substituted acrylamides (e.g., alkylacrylamides, N-methylolacrylamide, N-isopropylacrylaminde, diacetone acrylamide, N-alkyl acrylamide (where alkyl is C₁ to C₁₄), and N,N-dialkyl acrylamides (where alkyl is C₁ (e.g., N,N-dimethylacrylamide) to C₁₄), N-cycloalkane, N-(2-hydroxyethyl) acrylamide, N-isopropyl acrylamide, N-[3-(dimethylamino)propyl] acrylamide, or acryloylmorpholine). In embodiments wherein the at least one acrylamide monomer comprises an N-substituted acrylamide, the N-substituted acrylamide may comprise N,N-dialkyl acrylamides (e.g., N,N-dimethylacrylamide). The alkyl groups of the N,N-dialkyl acrylamides may be linear, branched, or cyclic. In some embodiments, the at least one acrylamide monomer comprises N,N-dimethylacrylamide.

The at least one sulfonated anionic monomer may include one or more of 2-acrylamido-2-methyl-propanesulfonic acid (also referred to as acrylamide tertiary butyl sulfonic acid (ATBS)), vinyl sulfonates, styrene sulfonic acid, allyl sulfonates, or styrene sulfonic acid. The at least one sulfonated anionic monomer may facilitate tolerance of the viscosifier to divalent cations in the drilling fluid brine, such as calcium and magnesium. In some embodiments, the at least one sulfonated anionic monomer is provided as a salt, such as an ammonium salt. For example, the at least one sulfonated anionic monomer may be provided as an ammonium salt of 2-acrylamido-2-methyl-propanesulfonic acid or a sodium salt of 2-acrylamido-2-methyl-propanesulfonic acid.

The viscosifier may constitute from about 0.05 weight percent to about 6.0 weight percent of the drilling fluid, such as from about 0.05 weight percent to about 0.10 weight percent, from about 0.10 weight percent to about 0.50 weight percent, from about 0.50 weight percent to about 1.0 weight percent, from about 1.0 weight percent to about 2.0 weight percent, from about 2.0 weight percent to about 3.0 weight percent, or from about 3.0 weight percent to about 6.0 weight percent of the drilling fluid. In some embodiments, the viscosifier may be present in the drilling fluid at a concentration as low as 0.25 ppb. However, the disclosure is not so limited, and the weight percent of the viscosifier in the drilling fluid may be different than that described.

The fluid loss material may include starch, modified starch (e.g., crosslinked starch, carboxymethyl starch, hydroxyethyl starch, hydroxypropyl starch, hydrophobically-modified starch), polyanionic starch, xanthan gum, polyanionic cellulose, carboxymethylcellulose, carboxymethyl hydroxyethylcellulose, hydroxyalkylcellulose, hydrophobically-modified cellulose (e.g., cellulose modified by lauryl glycidyl ether or cetyl glycidyl ether), glycogen, locust bean gums, wellan gum, scleroglucan gum, guar gum, alginate, carrageenan (e.g., one or more of i-carrageenan, k-carrageenan, l-carrageenan) (also referred to as carrageenan gum), gellan gum, alginate, synthetic polymers, styrene, styrene-butadiene, a vinyl polymer, or another polymer. In some embodiments, the fluid loss material includes starch, such as hydrophobically-modified starch.

Fluid thinners may include lignosulfates, lignitic materials, modified lignosulfonates, polyphosphates, tannin, and polyacrylates. The thinners may facilitate improved rheological properties of the drilling fluid (e.g., a reduction in flow resistance) and a reduction in gel development. In addition, the thinner may reduce a thickness of filtercakes formed by the drilling fluid, counteract the effects of salts, and reduce the effects of water on the earth formation 101.

Weighting materials (also referred to as “weighting agents”) may include one or more of barite (BaSO₄), iron oxide (e.g., Fe₂O₃, Fe₃O₄), calcium carbonate (CaCO₃), magnesium carbonate (MgCO₃), manganese oxide (Mn₃O₄), or combinations thereof. The weighting material may be present in the drilling fluid and facilitate increasing the density of the drilling fluid up to about 2.88 g/cm³ (about 24 pounds per gallon (ppg)).

The pH buffer may include an amine stabilizer, such as one or more of triethanolamine (C₆H₁₅NO₃) (TEOA), methyldiethanol amine (C₅H₁₃NO₂) (MDEA), dimethylethanol amine (C₄H₁₁NO) (DMEA), diethanol amine (C₄H₁₁NO₂) (DEA), monoethanol amine (MEA), cyclic organic amines, sterically hindered amines, amides of fatty acid, or other suitable tertiary, secondary, or primary amines and ammonia. In some embodiments, the pH buffer includes magnesium oxide.

The emulsifiers may include calcium polyvalent metal soaps, phosphate esters, fatty acids, fatty acid soaps, alkylbenzene sulfonate, lime, amidoamines, and imidazolines. The corrosion inhibitor may include iron oxide, aluminum bisulfate, zinc carbonate, zinc chromate, an amine, or another material. The gelling agent may include one or more of a clay and a crosslinked polyvinylpyrrolidone, an acrylamide copolymer, guar, sodium bentonite, or another material. The shale inhibitor may include one or more of hexamethylenediamine (HMD), bis(hexamethylene)triamine (BHMT), amine tartaric salt, ammonium lauric salt, polyammonium, alkyl diammonium, an amphoteric polymer, an organosilicate polymer, a silicone polymer, or another material. Defoamers may include one or more of 2-octanol, oleic acid, paraffinic waxes, amide waxes, sulfonated oils, organic phosphates, silicone oils, mineral oils, or dimethylpolysiloxane.

The additional surfactants may include anionic surfactants, cationic surfactants, and/or non-ionic surfactants. The foaming agents may include a nonionic surfactant including polymeric materials. The scale inhibitors may include an acrylic acid polymer, a maleic acid polymer, or a phosphonate. The solvents may include hydrocarbon solvents.

In use and operation, the wettability modifier may be added to an aqueous-based drilling fluid. The wettability modifier may reduce the loss of the drilling fluid into the earth formation 101. For example, the wettability modifier may form oil-wet surfaces in the earth formation 101, increasing the capillary pressure of aqueous-based fluids in pores defined by the hydrophobic surface and reducing the amount of the aqueous-based drilling fluid that is imbibed by pores of the earth formation 101. In addition, modifying the wettability of the surfaces of the earth formation 101 may increase the recovery of hydrocarbons from hydrocarbon-containing reservoirs within the earth formation 101 during a recovery or production operations.

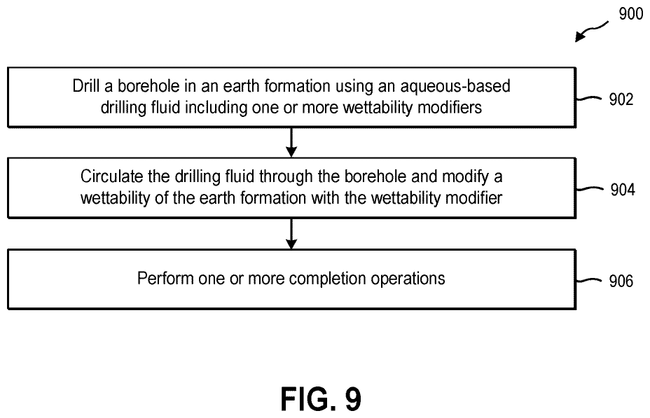

FIG. 9 is a simplified flow diagram illustrating a method 900 of drilling a borehole using a drilling fluid including a wettability modifier, according to at least one embodiment of the disclosure. The method 900 includes drilling a borehole in an earth formation using an aqueous-based drilling fluid including one or more wettability modifiers, as shown at act 902. The wettability modifier may include one or more of the wettability modifiers described above. For example, the wettability modifiers may include one or more the surfactants (e.g., a cationic ethoxylated alcohol, a cationic polymerized polyglucoside, a block copolymer of ethylene oxide and propylene oxide) and/or one or more the polymers (e.g., a polymer of N-isopropylacrylamide and at least one of acrylamide or AMPS, or a polymer of diethylacrylamide and at least one of acrylamide or AMPS) described above. In some embodiments, the wettability modifier includes at least one polar group and/or at least a hydrophilic portion to facilitate solubility of the wettability modifier in the aqueous-based drilling fluid.

The method 900 may include circulating the drilling fluid through the borehole and modifying a wettability of the earth formation with the wettability modifier, as shown in act 904. For example, the drilling fluid may be pumped from the surface of the earth formation (e.g., earth formation 101), through the drill string, out of the bit, and through the annulus between the drill string and the earth formation. The wettability modifier may contact surfaces of the earth formation, such as surfaces defining pores of the earth formation and modify (e.g., alter, change) the wettability of the surfaces to oil-wet. In some embodiments, the wettability modifier modifies the wettability of the surfaces of the earth formation from water-wet to oil-wet or a mixed-wet condition (including some water-wet surfaces and some oil-wet surfaces). In some embodiments, responsive to exposure to one or more conditions within the borehole and/or the earth formation, the wettability modifier may exhibit hydrophobic properties. For example, responsive to exposure to salt and a temperature greater than a predetermined temperature (e.g., greater than about 37.8° C. (about 100° F.)), the wettability modifier may exhibit hydrophobic properties. In some embodiments, circulating the drilling fluid through the borehole includes changing the wettability modifier to exhibit hydrophobic properties.

Responsive to contacting the surfaces of the earth formation, the wettability modifier may interact with hydrophilic (e.g., water-wet) surfaces of the earth formation to change the surfaces to oil-wet. In some embodiments, the wettability modifier attaches (e.g., physically attaches, chemically attaches) to the surfaces of the earth formation, such as by one or more of cationic exchange, cationic bridging, hydrogen bonding, van der Waals forces, or other mechanisms.

Responsive to modifying the wettability of the earth formation, the method 900 may further include completing the drilling operation and performing one or more completion operations, as shown in act 906. For example, act 906 may include casing at least a portion of the borehole and cementing the casing to the at least a portion of the borehole to form a wellbore. In some embodiments, after cementing the at least a portion of the borehole, the drilling operation may continue by drilling another portion of the earth formation below (downhole) from the cased and cemented portion of the wellbore. In some embodiments, after completing a drilling operation, one or more wellbore operations may include a stimulation operation, a perforation operation, a fracturing operation, a completion operation, and/or a production operation.

Forming the drilling fluid to include the wettability modifier may facilitate improved stability of the borehole, wellbore, and/or earth formation during drilling and subsequent operations. The wettability modifier may modify the wettability of surfaces of the earth formation and form at least some oil-wet surfaces. Accordingly, when drilling with an aqueous-based drilling fluid including the wettability modifier, the wettability modifier may reduce the amount of the aqueous-based drilling fluid that infiltrates (e.g., is imbibed by) the earth formation. Reducing the amount of the drilling fluid that remains in pores of the earth formation may reduce damage to the earth formation and facilitate improved recovery of hydrocarbons from the earth formation (e.g., through the oil-wet surfaces of the pores of the earth formation) during subsequent wellbore operations.

The embodiments of drilling fluids including the wettability modifier have been primarily described with reference to wellbore drilling operations; the drilling fluids described herein may be used in applications other than the drilling of a wellbore or borehole. In other embodiments, wellbore fluids including the wettability modifier according to the present disclosure may be used outside a wellbore, borehole, or other downhole environment used for the exploration or production of natural resources. Accordingly, the terms “wellbore,” “borehole,” and the like should not be interpreted to limit tools, systems, assemblies, or methods of the present disclosure to any particular industry, field, or environment. In addition, the drilling fluids may be used in cased completion wellbores and in open hole completion wellbores.

In some embodiments, the drilling fluids may be used during formation of a borehole and/or wellbore to be used for carbon capture, utilization, and storage (CCUS) and/or for recovery and use of geothermal energy. For example, the drilling fluids may be used to form boreholes and/or wellbores without introducing materials to the earth formation that may impede subsequent storage of carbon in the earth formation.

Geothermal energy is a promising source of renewable energy that captures energy from heat generated within the earth. For example, geothermal energy may be used to heat structures (e.g., buildings) and/or to generate electricity (e.g., by heating water to generate steam and drive a turbine with the steam). The drilling fluids described herein may be used to form boreholes and/or wellbores used to circulate a fluid that is heated within the earth formation through which the borehole and/or wellbore extends. The heated fluid may be circulated to the surface where the captured heat may be recovered to heat a structure and/or generate electricity, followed by recirculation of the fluid to the earth formation to continue the cycle.

CCUS facilitates the capture, use, and/or storage of carbon (e.g., carbon dioxide), which has a goal of achieving carbon neutrality and/or net zero carbon emissions (NZE). CCUS may facilitate the capture of carbon dioxide from large point sources (e.g., power plants, refineries, cement plants, other industrial processing plants, or other industrial facilities that use fossil fuels, biomass fuels, or other fuels that generate carbon dioxide). The captured carbon dioxide may be converted into valuable products such as, for example, ethanol, sustainable aviation fuel, chemicals, and mineral aggregates. Alternatively, the carbon dioxide may be stored in geologic formations, such as in depleted hydrocarbon reservoirs. The carbon dioxide may be introduced into the earth formation through a borehole and/or wellbore formed using the drilling fluids described herein. In the earth formation, the carbon dioxide may be dispersed in an aqueous phase and stored as carbon dioxide, in mineral form (e.g., as a carbonate, such as calcium carbonate, magnesium carbonate, iron(II) carbonate), or as another form of carbon.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A drilling fluid, comprising:
an aqueous base fluid including:
water; and
salt; and
a wettability modifier including one or more of a cationic ethoxylated alcohol including a quaternary ammonium cation, a cationic polymerized polyglucoside, a block copolymer of ethylene oxide and propylene oxide, a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid.

2. The drilling fluid of claim 1, wherein the wettability modifier is configured to exhibit hydrophobic properties responsive to exposure to a temperature greater than about 37.8° C.

3. The drilling fluid of claim 1, wherein the wettability modifier constitutes from about 1.0 volume percent to about 5.0 volume percent of the drilling fluid.

4. The drilling fluid of claim 1, wherein the wettability modifier has a number average molecular weight within a range of from about 1,000 g/mol to about 100,000 g/mol.

5. The drilling fluid of claim 1, wherein the cationic ethoxylated alcohol including a quaternary ammonium cation has the following structure:

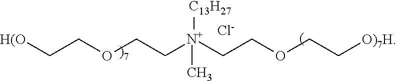

6. The drilling fluid of claim 1, wherein the wettability modifier includes one or more of the cationic ethoxylated alcohol including a quaternary ammonium cation, the cationic polymerized polyglucoside, or the block copolymer of ethylene oxide and propylene oxide.

7. The drilling fluid of claim 1, wherein the wettability modifier includes a poly(ethyleneoxide)/poly(propyleneoxide) triblock copolymer.

8. The drilling fluid of claim 1, wherein the wettability modifier includes a cationic polymerized alkyl polyglucoside including tertiary cationic groups.

9. The drilling fluid of claim 1, wherein the wettability modifier includes the following structure: 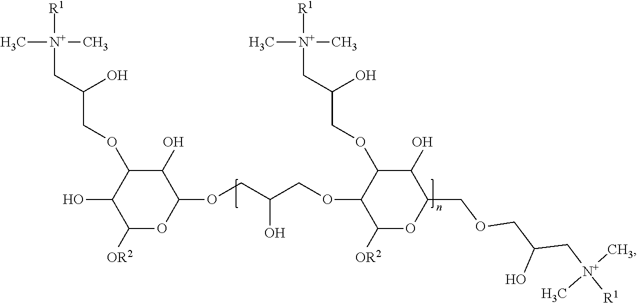
wherein R¹ includes one or more of lauryl group, a stearyl group, or a methyl group, and R² includes one or more of a decyl group, a lauryl group, or a coco group.

10. The drilling fluid of claim 1, wherein the wettability modifier includes the following structure:

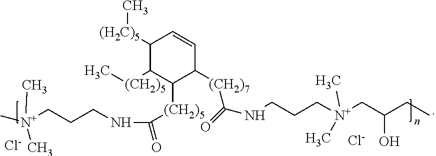

11. The drilling fluid of claim 1, wherein the wettability modifier includes a copolymer of N-isopropylacrylamide and one of acrylamide or 2-acrylamido-2-methylpropane sulfonic acid or a terpolymer of N-isopropylacrylamide and each of acrylamide or 2-acrylamido-2-methylpropane sulfonic acid.

12. The drilling fluid of claim 11, wherein the polymer includes a greater number of monomer units of N-isopropylacrylamide than a total number of monomer units of the acrylamide and 2-acrylamido-2-methylpropane sulfonic acid.

13. The drilling fluid of claim 1, wherein the wettability modifier includes a copolymer of diethylacrylamide and one of acrylamide or 2-acrylamido-2-methylpropane sulfonic acid or a terpolymer of diethylacrylamide and each of acrylamide or 2-acrylamido-2-methylpropane sulfonic acid.

14. The drilling fluid of claim 1, wherein the wettability modifier includes:
one or more of the cationic ethoxylated alcohol including a quaternary ammonium cation, the cationic polymerized polyglucoside, or the block copolymer of ethylene oxide and propylene oxide; and
one or both of the polymer of N-isopropylacrylamide and at least one of acrylamide or 2-acrylamido-2-methylpropane sulfonic acid or the polymer of diethylacrylamide and at least one of acrylamide or 2-acrylamido-2-methylpropane sulfonic acid.

15. The drilling fluid of claim 1, further comprising a viscosifier.

16. A method of drilling a borehole, the method comprising:
drilling a borehole in an earth formation using a drilling fluid comprising:
a base fluid comprising:
water; and
salt; and
a wettability modifier comprising one or more of a cationic ethoxylated alcohol including a quaternary ammonium cation, a cationic polymerized polyglucoside, a block copolymer of ethylene oxide and propylene oxide, a polymer of N-isopropylacrylamide and at least one of acrylamide or 2-acrylamido-2-methylpropane sulfonic acid, or a polymer of diethylacrylamide and at least one of acrylamide or
2-acrylamido-2-methylpropane sulfonic acid;
exposing the wettability modifier to one or more conditions within the borehole to impart hydrophobic properties on the wettability modifier; and
contacting surfaces of the earth formation with the wettability modifier to form oil-wet surfaces on the earth formation.

17. The method of claim 16, wherein exposing the wettability modifier to one or more conditions within the borehole to impart hydrophobic properties on the wettability modifier includes exposing the wettability modifier to the salt at a temperature greater than about 37.8° C.

18. The method of claim 16, wherein drilling a borehole in an earth formation includes drilling the borehole using a drilling fluid including a cationic surfactant.

19. The method of claim 16, wherein drilling a borehole in an earth formation includes drilling the borehole using a polymer including at least one of N-isopropylacrylamide or diethylacrylamide.

20. A drilling fluid, comprising:
an aqueous base fluid including:
water, and
salt; and
a temperature-responsive wettability modifier including:
one or more of a cationic ethoxylated alcohol including a quaternary ammonium cation, a cationic polymerized polyglucoside, or a block copolymer of ethylene oxide and propylene oxide; and
a polymer of N-isopropylacrylamide and at least one of acrylamide or 2-acrylamido-2-methylpropane sulfonic acid, or a polymer of diethylacrylamide and at least one of acrylamide or 2-acrylamido-2-methylpropane sulfonic acid.
